(19) United States
(12) Patent Application Publication
(10) Pub. No.: US 2014/0157104 A1
(43) Pub. Date: Jun. 5, 2014

(54) DYNAMIC SHARING AND UPDATING OF A WEB PAGE

(71) Applicant: SOARIC AB, Malmo (SE)

(72) Inventor: Esben CARLSEN, Malmo (SE)

(73) Assignee: Soaric AB, Malmo (SE)

(21) Appl. No.: 13/691,245

(22) Filed: Nov. 30, 2012

(51) Int. Cl. G06F 17/22

(52) U.S. Cl. CPC G06F 17/2247
USPC 715/234

(57) ABSTRACT

A server (450) comprising a memory (240) and a controller (210), wherein said controller (210) is configured to receive a code representation from a customer terminal, adapt said code representation, store said adapted code representation and forward an address for accessing the adapted code representation to an operator terminal, thereby sharing a web page through its code representation between a customer terminal and an operator terminal.

### TECHNICAL FIELD

This application relates to a method, an apparatus and a computer program product for sharing a web page, and in particular to a method, an apparatus and a computer program product for dynamic sharing and updating of a web page.

### BACKGROUND

In today's society many solutions as to how companies invest heavily in establishing an electronic business focused at providing customers with electronic commerce possibilities. Companies and institutions also invest in providing online registration. Electronic commerce, commonly known as e-commerce, ecommerce or e-comm, refers to the buying and selling of products or services over electronic systems such as the Internet and other computer networks.

However, due to the large number of available services users may sometimes become lost or confused and be in need of assistance. Such assistance may be provided by an operator to a customer by sharing the customer's terminal's display view by capturing the graphic content, that is image data corresponding to a displayed view and sending the graphic content to an operator. One such system is disclosed in the American patent application US 20080016155. The captured graphic content is processed by image processing to determine what data to send to the operator which consumes processing resources. Furthermore, by only presenting graphic content to an operator, the operator is not able to interact with the displayed content, but is forced to verbally guide a customer, something which is not always easy, especially for technically inept users or when the user and the operator are not speaking in their native tongue. The screen sharing of US 20080016155 is thus highly inefficient as it requires lots of resources while being limited when it comes to options for the operator. It is also difficult to utilize when an operator is servicing many customers and in many other operator-customer combinations.

There is thus a need to be able to share a display view in a fast and efficient manner that is easy to understand, which allows the screen to be truly shared between a customer and an operator.

### SUMMARY

It is an object of the teachings of this application to overcome at least the problems listed above by providing a server comprising a memory and a controller, wherein said controller is configured to receive a code representation from a customer terminal, adapt said code representation, store said adapted code representation and forward an address for accessing the adapted code representation to an operator terminal, thereby sharing a web page through its code representation between a customer terminal and an operator terminal.

In one embodiment the code representation is a DOM (Document Object Model) tree. This allows for enabling a sharing of a web page where both the customer terminal and the operator terminal can take advantage of the full functionality of the web page.

It is an object of the teachings of this application to overcome at least the problems listed above by providing a customer terminal comprising a memory, a display and a controller, wherein said controller is configured to connect to a web server; request and receive code corresponding to a web page from said web server and display said web page on a display, retrieve a code representation of said web page from said memory and forward said code representation to a server according to above.

It is an object of the teachings of this application to overcome at least the problems listed above by providing an operator terminal comprising a memory and a controller, wherein said controller is configured to connect to a server according to above, receive an address to an adapted copy of a web page, access said adapted copy of a web page through the received address for obtaining a shared view of the web page.

This has the benefits of enabling a sharing of a web page that is easy to use, allows the operator to actively guide the customer and does not require resource demanding image processing. A further benefit is that the manner taught herein is capable of being executed on a wide range of devices and apparati. Furthermore, having the rendered view in the operator view enables an intelligent interaction with content being displayed, whereas this is not possible with a screenshot, because it would be nearly impossible (or at least requiring significant effort) to determine individual components of a DOM tree in a screenshot.

It is also an object of the teachings of this application to overcome the problems listed above by providing a method for use in a server, said method comprising receiving a code representation from a customer terminal, adapting said code representation, storing said adapted code representation and forwarding an address for accessing the adapted code representation to an operator terminal, thereby sharing a web page through its code representation between a customer terminal and an operator terminal

It is also an object of the teachings of this application to overcome the problems listed above by providing a method for use in a customer terminal comprising a memory, a display and a controller, said method comprising connecting to a web server, requesting and receiving code corresponding to a web page from said web server and display said web page on a display, retrieving a code representation of said web page from said memory and forwarding said code representation to a server according to above.

It is also an object of the teachings of this application to overcome the problems listed above by providing a method for use in an operator terminal comprising a memory and a controller, said method comprising connecting to a server according to above, receiving an address to an adapted copy of a web page, accessing said adapted copy of a web page through the received address for obtaining a shared view of the web page.

It is also an object of the teachings of this application to overcome the problems listed above by providing a computer program product or computer readable storage medium encoded with instructions that, when executed on a processor, performs the methods according to above.

The authors of the present application have realized, after inventive and insightful reasoning, that by sharing the code representing the web page a fast and efficient sharing of the web page is achieved providing both the operator and the customer full access to all the functionality of the web page that is to be shared.

The teachings herein find use in providing assistance for online services such as online shops, registrations, ordering services, public systems, banking systems, ticketing services, such as flight bookings, train bookings and hotel bookings, or other services. The teachings herein also find beneficial use in systems of online services allowing a multitude of services to be supported by one service agent or operator due to the versatility of the system disclosed herein.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of the element, device, component, means, step, etc., unless explicitly stated otherwise. The actions of any method disclosed herein do not have to be performed in the exact order disclosed, unless explicitly stated.

### BRIEF DESCRIPTION OF DRAWINGS

The invention will be described in further detail under reference to the accompanying drawings in which:

FIGS. 1A, 1B, 1C and 1D are each a schematic view of a communication apparatus according to an embodiment of the teachings herein;

FIG. 2 is a schematic view of the components of a communication apparatus according to the teachings herein;

FIG. 3 is a schematic view of a computer-readable medium according to the teachings herein;

FIG. 4 shows general view of a system according to one embodiment of the teachings of this application;

FIG. 5 shows a flowchart for a method according to one embodiment of the teachings of this application;

FIG. 6 shows a hand-shake diagram for a screen sharing operation according to one embodiment of the teachings of this application;

FIGS. 7A, 7B, 7C and 7D each shows a schematic view of a web page being displayed and shared according to one embodiment of the teachings of this application;

FIG. 8 shows a hand-shake diagram for a screen sharing operation according to one embodiment of the teachings of this application; and

FIG. 9 shows a hand-shake diagram for a screen sharing operation according to one embodiment of the teachings of this application.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

In one embodiment a communication apparatus is configured for network communication, either wireless or wired. In one embodiment the communication apparatus is configured for network communication, both wireless and wired. Examples of such a communication apparatus are: a personal computer, desktop or laptop, an internet tablet, a mobile telephone, a smart phone, a personal digital assistant, a work station and potentially any future network enabled device. The communication apparatus may be exemplified and described as being a computer. The personal computer or terminal comprises a display and a housing. The housing comprises a controller or CPU and one or more computer-readable storage mediums, such as storage units and internal memory. Examples of storage units are disk drives or hard drives. The terminal further comprises at least one data port. Data ports can be wired and/or wireless. Examples of data ports are USB (Universal Serial Bus) ports, Ethernet ports or Wi-Fi (according to IEEE standard 802.11) ports. Data ports are configured to enable a terminal to connect with other terminals or a server.

The terminal further comprises at least one input unit such as a keyboard. Other examples of input units are computer mouse, touch pads, touch screens or joysticks to name a few.

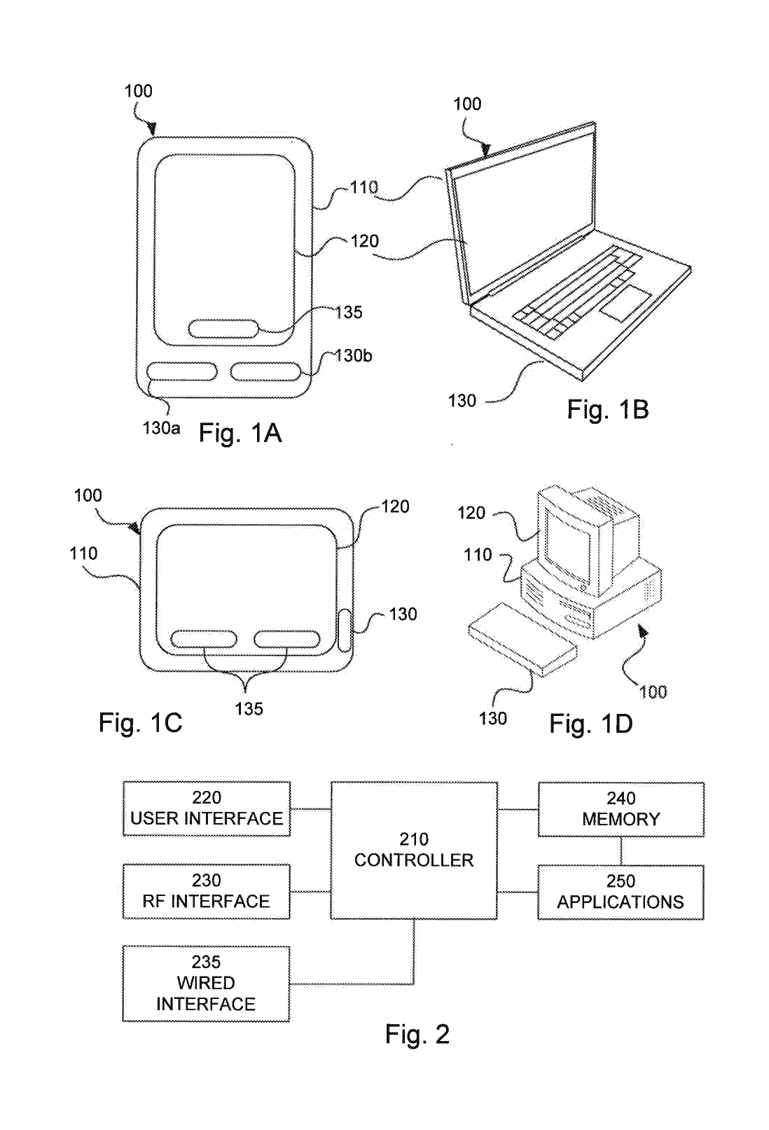

FIGS. 1A, 1B, 1C and 1D generally show a communication apparatus 100 according to an embodiment herein. Examples of such a communication apparatus 100 are: a personal computer, desktop or laptop, an internet tablet, a mobile telephone, a smart phone and a personal digital assistant. Four embodiments will be exemplified and described as being a mobile telephone, such as a smartphone, in FIG. 1A, a laptop computer in FIG. 1B, an internet tablet in FIG. 1C and a desktop computer or terminal 100 in FIG. 1D.

Referring to FIG. 1A a smartphone 100 comprises a housing 110 in which a display 120 is arranged. In one embodiment the display 120 is a touch display. In other embodiments the display 120 is a non-touch display. Furthermore, the smartphone 100 comprises two keys 130a, 130b. In this embodiment there are two keys 130, but any number of keys is possible and depends on the design of the smartphone 100. In one embodiment the smartphone 100 is configured to display and operate a virtual key 135 on the touch display 120. It should be noted that the number of virtual keys 135 are dependant on the design of the smartphone 100 and an application that is executed on the smartphone 100.

Referring to FIG. 1B a computer 100, in this example a laptop computer 100, comprises a display 120 and a housing 110. The housing comprises a controller or CPU (not shown) and one or more computer-readable storage mediums (not shown), such as storage units and internal memory. Examples of storage units are disk drives or hard drives. The laptop computer 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable the laptop computer 100 to connect with other communication apparatuses or a server. The laptop computer 100 further comprises at least one input unit such as a keyboard 130. Other examples of input units are computer mouse, touch pads, touch screens or joysticks to name a few.

Referring to FIG. 1C an internet tablet 100 comprises a housing 110 in which a display 120 is arranged. In one embodiment the display 120 is a touch display. In other embodiments the display 120 is a non-touch display. Furthermore, the internet tablet 100 may comprise one or more keys 130. In this embodiment there is one key 130, but any number of keys is possible and depends on the design of the internet tablet 100. In one embodiment the internet tablet 100 is configured to display and operate one or more virtual keys 135 on the touch display 120. It should be noted that the number of virtual keys 135 are dependant on the design of the internet tablet 100 and an application that is executed on the internet tablet 100.

Referring to FIG. 1D a desktop terminal 100, in this example a desktop computer 100, comprises a display 120 and a housing 110. The housing comprises a controller or CPU (not shown) and one or more computer-readable storage mediums (not shown), such as storage units and internal memory. Examples of storage units are disk drives or hard drives. The desktop computer 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable the desktop computer 100 to connect with other communication apparatuses or a server. The desktop computer 100 further comprises at least one input unit such as a keyboard 130. Other examples of input units are computer mouse, touch pads, digital pens or joysticks to name a few.

It should be noted that a desktop computer may be used to implement a server, such as a web server. In such an embodiment the server may have a remote input unit 130 and/or a remote display 110 that is shared among other servers, or it is accessed only via its radio interface or its wired interface. The input unit and/or a display are then the input unit and/or a remote display of the accessing terminal

FIG. 2 shows a schematic view of the general structure of a communication apparatus according to FIGS. 1A, 1B, 1C and 1D. The communication apparatus 200 comprises a controller 210 which is responsible for the overall operation of the communication apparatus 200 and is preferably implemented by any commercially available CPU (“Central Processing Unit”), DSP (“Digital Signal Processor”) or any other electronic programmable logic device. The controller 210 may be implemented using instructions that enable hardware functionality, for example, by using executable computer program instructions in a general-purpose or special-purpose processor that may be stored on a computer readable storage medium (disk, memory etc) 240 to be executed by such a processor. The controller 210 is configured to read instructions from the memory 240 and execute these instructions to control the operation of the communication apparatus 200. The memory 240 may be implemented using any commonly known technology for computer-readable memories such as ROM, RAM, SRAM, DRAM, CMOS, FLASH, DDR, EEPROM memory, flash memory, hard drive, optical storage or any combination thereof. The communication apparatus 200 further comprises one or more applications 250. The applications are sets of instructions that when executed by the controller 210 control the operation of the communication apparatus 200. The memory 240 is used for various purposes by the controller 210, one of them being for storing application data and program instructions 250 for various software modules in the communication apparatus 200. The software modules include a real-time operating system, drivers for a man-machine interface 220, an application handler as well as various applications 250. The applications 250 can include a messaging application such as electronic mail, a browsing application, a media player application, as well as various other applications 250, such as applications for voice calling, video calling, document reading and/or document editing, an instant messaging application, a calendar application, a control panel application, one or more video games, a notepad application, etc.

The communication apparatus 200 further comprises a user interface 220, which in the communication apparatus 100 of figure of 1a, 1B, 1C or 1D, is comprised of the display 110, the keypad 130. The user interface (UI) 220 also includes one or more hardware controllers, which together with the UI drivers cooperate with the display 110, keypad 130, as well as various other I/O devices such as sound system, LED indicator, etc. As is commonly known, the user may operate the communication apparatus 200 through the man-machine interface thus formed. As has been disclosed in relation to FIG. 1Dm, if the communication apparatus is a server, the user interface may be remote.

The communication apparatus 200 further comprises a radio frequency interface 230, which is adapted to allow the communication apparatus to communicate with other devices through a radio frequency band through the use of different radio frequency technologies.

Examples of such technologies are WIFI, Bluetooth®, W-CDMA, GSM, UTRAN, LTE, and NMT to name a few.

The communication apparatus 200 further comprises a wired interface 235, which is adapted to allow the communication apparatus to communicate with other devices through the use of different network technologies. Examples of such technologies are USB, Ethernet, and Local Area Network, TCP/IP (Transport Control Protocol/Internet Protocol) to name a few.

The controller 210 is configured to operably execute applications 250 such as the web browsing or email application through the RF interface 230 and/or the wired interface 235 using software stored in the memory 240 which software includes various modules, protocol stacks, drivers, etc. to provide communication services (such as transport, network and connectivity) for the RF interface 230 and the wired interface 235, and optionally a Bluetooth interface and/or an IrDA interface for local connectivity. The RF interface 230 comprises an internal or external antenna as well as appropriate radio circuitry for establishing and maintaining a wireless link to a base station. As is well known to a person skilled in the art, the radio circuitry comprises a series of analogue and digital electronic components, together forming a radio receiver and transmitter. These components include, i.e., band pass filters, amplifiers, mixers, local oscillators, low pass filters, AD/DA converters, etc.

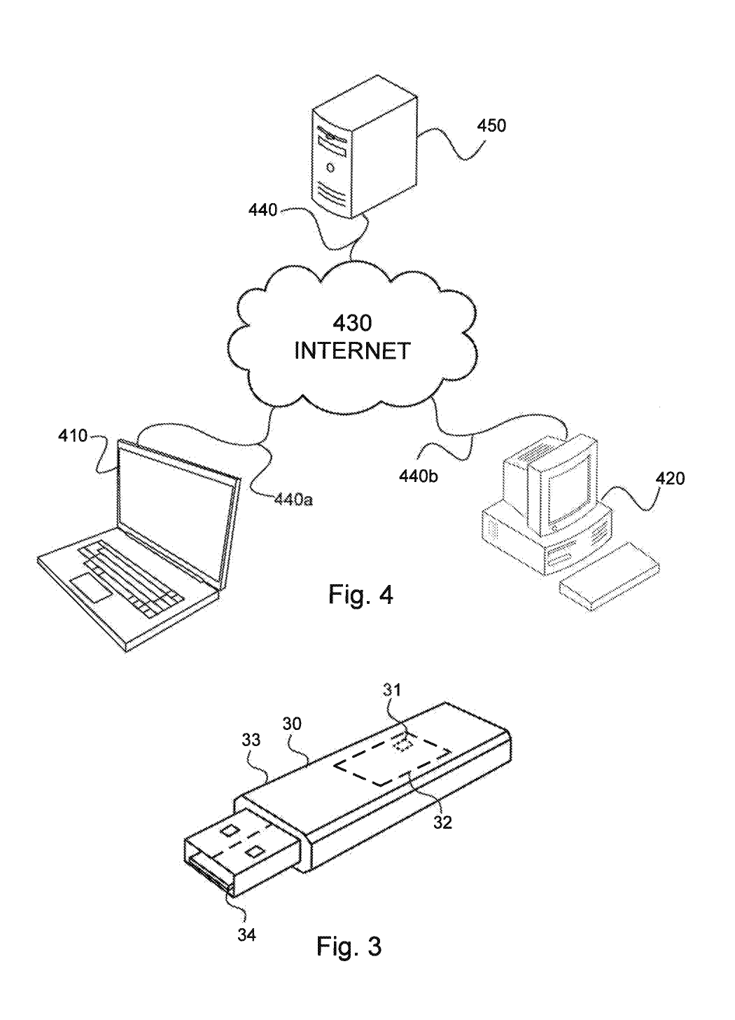

FIG. 3 shows a schematic view of a computer-readable medium 32 as described in the above. The computer-readable medium 32 is in this embodiment housed in a memory stick 30, such as a Universal Serial Bus (USB) stick. The USB stick 30 comprises a housing 33 having an interface, such as a connector 34, and a memory chip 32. In this embodiment the memory chip 32 is a flash memory, that is, a non-volatile data storage that can be electrically erased and re-programmed The memory chip 32 is programmed with instructions 31 that when loaded (possibly via the interface 44) into a controller, such as a processor, executes a method or procedure according to the embodiments disclosed above. The USB stick is arranged to be connected to and read by a reading device, such as a communication apparatus 100, 200 according to FIGS. 1 and 2, for loading the instructions into the controller (referenced 210 in FIG. 2). It should be noted that a computer-readable medium can also be other mediums such as compact discs, digital video discs, hard drives or other memory technologies commonly used. The instructions can also be downloaded from the computer-readable medium via a wireless interface to be loaded into the controller.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 4 shows a schematic overview of a computer network 400 according to an embodiment herein. A first communication apparatus 410, such as the laptop computer 100 of FIG. 1B, is connected via the internet 430 to a second communication apparatus 420, such as the desktop computer 100 of FIG. 1D. In FIG. 4 there are two communication apparatuses 410 and 420, but it should be noted that any number of communication apparatuses may be connected to the internet and to each other. Particularly, there may be more than one first communication apparatus 410 connected to the second communication apparatus 420. The computer network further comprises at least one server 450. In FIG. 4 only one server 450 is shown, but it should be noted that any number of servers 450 may be implemented in a computer network 400. Generally a server is a physical computer (a hardware system) dedicated to running one or more services (as a host), to serve the needs of customers of the other computers or communication apparatuses 410, 420 in the network 400. Depending on the computing service that it offers it could be a database server, file server, mail server, print server, web server, or other. A server may be implemented as a computer such as has been disclosed above with reference to FIGS. 1D and 2.

In one embodiment the server 450 is a server 450. Generally, a server 450 can refer to either hardware (a computer) or software (a computer application) that helps to deliver content that can be accessed through the Internet 430.

It should be noted that the server 450 may be the server providing the web service that the web page is downloaded from. However, in the examples given below, the server 450 will be a separate server via which the operator terminal is able to provide assistance to the customer terminal.

The Internet 430 is a global system of interconnected computer networks that use the standard Internet protocol suite (TCP/IP—Transmission Control protocol/Internet Protocol) to serve billions of customers worldwide. It is a network of networks that consists of millions of private, public, academic, business, and government networks, of local to global scope, that are linked by a broad array of electronic, wireless and optical networking technologies. The Internet carries a vast range of information resources and services, such as the inter-linked hypertext documents of the World Wide Web (WWW) and the infrastructure to support communication applications such as email and Voice over Internet Protocol (VoIP) to name a few. The communications infrastructure of the Internet 430 consists of its hardware components; such as servers and communication apparatuses and a system of software layers arranged in protocols according to an internet model that control various aspects of the architecture. The most prominent component of the Internet model is the Internet Protocol (IP), which provides addressing systems (IP addresses) for computers on the Internet. As would be apparent to a skilled reader, the internet is full of possibilities and variations of how to connect two communication apparatuses and the embodiments disclosed herein are for purely exemplary purposes and should not be construed to be limiting.

In one embodiment the communication apparatuses 410 and 420 are configured to access the internet through a web browser (referenced 250 in FIG. 2). The web browser is configured to receive code segments and execute these code segments to display and operate a web page representing a web service. Such code segments may be HTML (Hyper Text Markup Language) code or Java Applet or JavaScript® code or a combination.

By using Java Applet or JavaScript code scripts in combination with HTML code a web page may be downloaded quickly and run without having to install special software in the hosting com app. Furthermore, the use of HTML code in combination with Java Applet or JavaScript code scripts enables the webpage to be dynamic and functional, while restricting the web page's access to the hosting com app's web browser, preventing access to other files and memory content. This is particular beneficial in that many contemporary smart phones and tablets do not support all formats of scripts, such as Java Applets. The manner taught herein is thus also highly flexible when it comes to which smartphones, internet tablets and other apparati that implements the manner herein.

By using a Java Applet or a JavaScript code script the operator's terminal is restricted to the data available through the customer terminal's browser application—at least without further authorization from the user of the customer terminal. Therefore, no additional trust between the operator and the customer needs to be established. The user has already indicated a trust relationship by entering the web page and either asking for or accepting help. The operator is not able to access any other file than the web page itself—without further authorization—and the assistance session can be performed under the same indicated trust relationship without risk to the user.

In one embodiment a combination of JavaScript and HTML code is used. By limiting the use to JavaScript and HTML code and not Java applets (or Java applications), the execution and download of code is very fast. The manner taught herein, according to such an embodiment, is also highly compatible with different devices running different operating systems.

In one embodiment of the network 400 of FIG. 4 the network 400 comprises a client or customer terminal 410 (the first communication apparatus) that is connected 440a to a web service operated and represented by the server 450. The web service is represented by a web page that is downloaded and displayed on the customer terminal 410. Examples of such web services are online registration systems, online shops, online booking systems and online support systems to name a few. The web page is specified through a combination of JavaScript code scripts and HTML code segments. The web browser (referenced 250 in FIG. 2) of the customer terminal 410 is configured to be executed by the controller (referenced 210 in FIG. 2) of the customer terminal 410 to request and receive the code of the web page from a web server, to parse it and to display the web page accordingly.

As the web browser parses, renders and executes the code returned from the webserver, it generates a code representation, such as an object model, to maintain an up-to-date of the web page. The code representation or object model comprises representations or identifiers for various objects (text, images, media or such) that are to be displayed as part of the webpage. In one embodiment the code representation is in the form of a Document Object Model (DOM) tree.

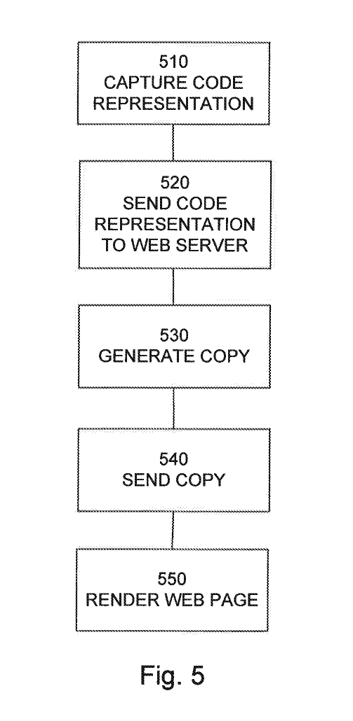

Should a user of the customer terminal 410 experience any difficulties while browsing the web page, the customer terminal 410 is enabled to provide him with a function that allows him to contact an operator. The general manner in which the operator terminal 420 is configured to assist the customer terminal 410 is illustrated in FIG. 5 which is a flowchart of a general method according to the teachings herein.

An operator terminal 420 (the second communication apparatus) is connected 440b to the web service through the server 450. The operator terminal 420 is enabled to communicate with the customer terminal 410 through the server 450 to offer support or assistance. The operator terminal 420 is configured to share a view of the web page representing the web service that is displayed on the customer terminal 410. The sharing of the web service is implemented in a combination of HTML code and JavaScript code scripts (as discussed above) which allows the operator to share a view of the customer's webpage and to make alterations to it, without having any control over the customer's terminal's other aspects. The web page sharing is enabled through JavaScript® code script that retrieves 510 the code representation of the web page and sends it 520 to the server 450. The server 450 parses the code representation to filter out all irrelevant data and also to replace all relative links with absolute links. By using absolute addresses, there is no need to transmit images or other data intensive content from customer terminal to the server. An adapted copy of the code representation is thus generated 530 by the server and sent 540 to the operator terminal 420. As the operator terminal 420 receives the code representation it renders and displays the resulting web page. The operator terminal is thus able to share an exact view of the web page that is displayed on the customer terminal without having to execute time and processing demanding image processing. The shared web page also has all the functionality of the web page displayed on the customer terminal 410.

By repeating the method above, the web page is effectively shared and all updates on the customer terminal 410 are reflected on the operator terminal 420. The customer terminal 410 may be configured to capture the code representation at certain time intervals, as an event happens or upon request from the operator terminal 420 or the server 450.

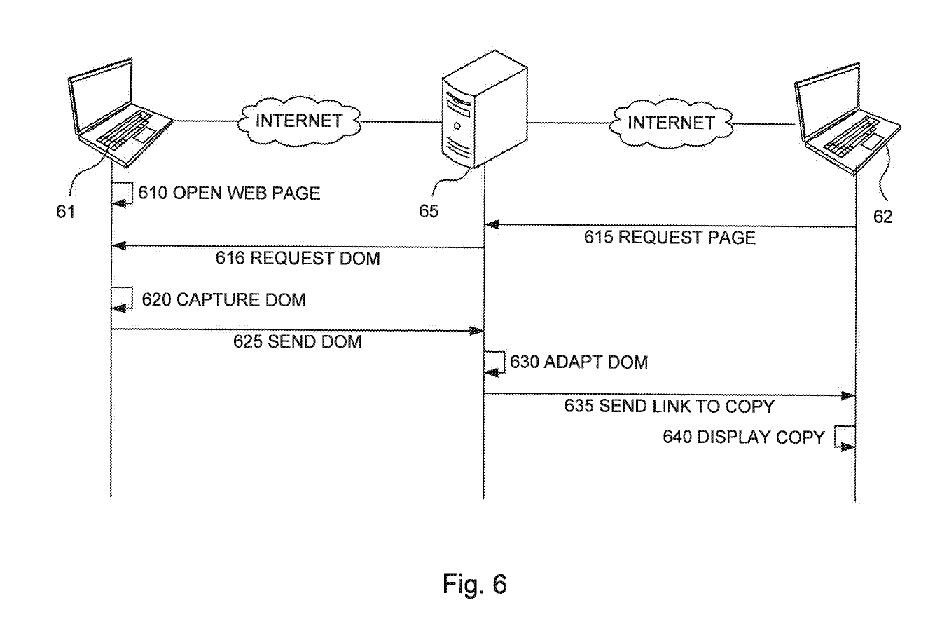

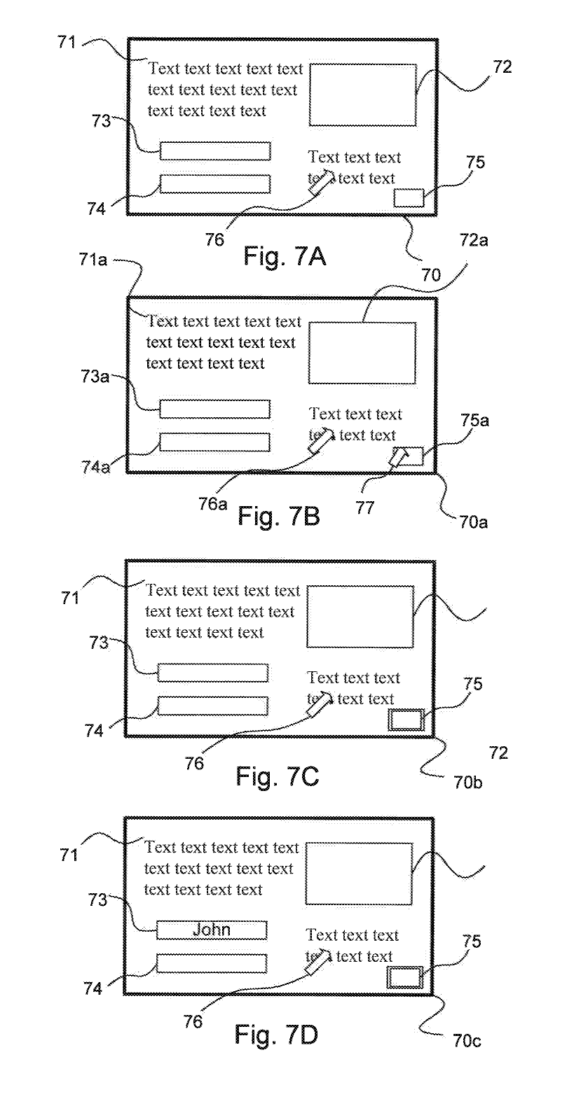

The manner of sharing a web page will be described in more detail with simultaneous reference to FIG. 6, showing a handshake diagram of a customer terminal, a server and an operator terminal, and FIGS. 7A and 7C each showing a web page 70 being displayed on a customer terminal and FIG. 7B showing a copy of the web page 70a being displayed on an operator terminal.

In FIG. 6 a customer terminal 61 opens a web page 610. FIG. 7A shows an example of such a web page 70 being displayed in a browser window on the customer terminal 61, such as a communication apparatus 100 in either of FIGS. 1A, 1B, 1C or 1D. The web page 70 comprises a text area 71, two form fields 73 and 74 and an image 72. The web page 70 also comprises a (virtual) button 75. Also displayed in the web browser window is a cursor 76. The cursor 76 is not specific to the web browser, but to the customer terminal 61.

As the user of the customer terminal 61 either requests assistance from an operator or an operator offers assistance to the user of the customer terminal 61, a communication path between the customer terminal 61 and an operator terminal 62, such as a communication apparatus 100 in either of FIGS. 1A, 1B, 1C or 1D, is established over the internet. This is indicated by the line joining the customer terminal 61 and the operator terminal 62 in FIG. 6.

The operator terminal 62 sends a request 615 for a copy of the web page 70 to a server 65 which forwards the request by sending a request 616 for a code representation of the web page, in this embodiment a copy of the DOM tree, to the customer terminal 61. The customer terminal 61 retrieves 620 the DOM tree for the presently displayed web page 70 and sends 625 the DOM tree to the server 65. In one embodiment, the DOM tree is retrieved by the controller executing AJAX commands. One benefit of retrieving and forwarding the DOM tree is that it is readily available, is of a small size, even for rather complicated web pages, and does not require resource demanding image processing. It also requires less bandwidth when transmitted to the server 65.

By enabling the retrieval of the customer terminal's code representation (DOM tree) instead of requesting a copy of the web page from the web server hosting the web service it is ensured that the operator will see the same content as is displayed on the customer terminal 61. It is common that the content of a web page is based on the identification or locality of the user requesting it. For example, if the user has an Internet Protocol address indicating a first language, say Swedish, and the operator has an Internet Protocol address indicating a second language (say Spanish) they may not receive the same web page. By retrieving the customer terminal's code representation such problems are avoided and overcome. Also, this avoids generating unnecessary traffic to and from the content server, thereby reducing the needed bandwidth. Furthermore, it voids generating duplicate statistics, thus reducing the required processor power and memory space.

The server 65 adapts 630 the DOM tree by removing irrelevant data, such as all or at least most of the JavaScript and HTML comments and code—which ensures that the view of (or rather the DOM tree for) the customer's display is not modified—, and by replacing relative addresses with absolute addresses thereby generating a copy of the web page. The server 65 thereafter sends 635 a link or address to the adapted copy of the web page to the operator terminal 62 which accesses an, downloads, renders and displays 640 the copy of the web page.

FIG. 7B shows a copy a web page 70a being displayed in a browser window on the operator terminal 62. The web page copy 70a comprises a text area 71a, two form fields 73a and 74a and an image 72a. The web page 70 also comprises a virtual button 75a. The components or objects in the web page copy 70a are the same as the components or objects in the web page 70 of FIG. 7A. In one embodiment the operator terminal is also configured to display a copy 76a of the customer terminal's cursor 76.

As the web page is manipulated or otherwise updated the server 65 receives a new copy of the DOM tree, adapts it and forwards a link to the operator terminal which displays the copy of the web page. Through this, the web page is effectively shared between the operator terminal 62 and the customer terminal 61. The update or refresh of the web page copy may be initiated by the customer terminal, the operator terminal 62, at specific time intervals or at specific events.

Also displayed is a cursor 77 of the operator terminal 62. The operator maneuvers the operator terminal cursor 77 to manipulate objects on the copy of the web page 70a. Any action taken by the operator on the web page copy 70a is propagated to the original web page 70 and the operator is thus able to manipulate the web page copy 70a just as if he was browsing the original web page. This will be illustrated by an example of a mouse click on button 75a in the web page copy 70a on the operator terminal 82.

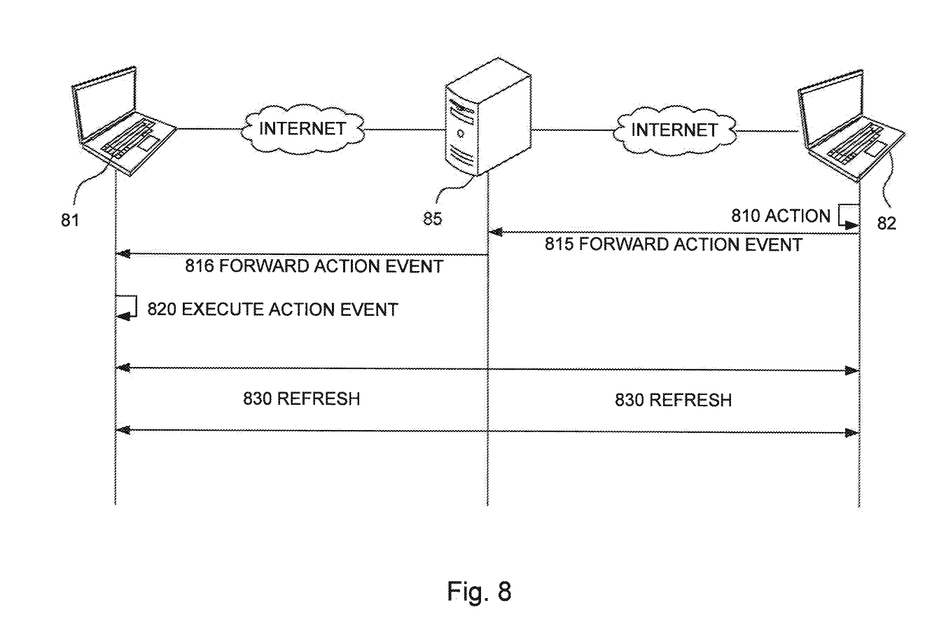

FIG. 8 shows a handshake diagram illustrating the functionality of such an operator action. The operator performs an action, in this example a mouse click on the virtual button 75a. The operator terminal receives 810 an operator action and generates an event or an indication corresponding to the operator action. The operator action event is forwarded 815 to the server 85. In one embodiment the operator action event is forwarded as a JavaScript command embedded in the payload data of a HTTP (HyperText Transfer Protocol) message. The server 85 forwards 816 the operator action event to the customer terminal 81. In one embodiment the operator action event is forwarded as a JavaScript command embedded in the payload data of a HTTP (HyperText Transfer Protocol) message. The customer terminal 81 executes 820 the operator action event locally so that the action made by the operator is effectively executed on the customer terminal, as if the user terminal 81 had initiated the operator action. In one embodiment the operator action event is executed as a HTTP (HyperText Transfer Protocol) command by the customer terminal 81.

FIG. 7C shows the web page 70b as the operator action, in this example a mouse click, is executed. The virtual button 75 is indicated as having been pressed by the double-lined frame of the virtual button 75. The resulting web page 70b may initiate a refresh 830 operation as disclosed with reference to FIG. 6.

This allows the operator to input both visual and direct guidance to the user of the customer terminal and the operator is thereby enabled to assist the customer directly on the web page. The web page is thus effectively shared between the customer and the operator.

The user of the customer terminal is still able to access and manipulate the webpage 70, just as before the assistance session was initiated, and any actions taken by the user will be reflected in the web page copy 70a on the operator terminal 62. This allows the operator to assist in what actions are to taken by the user and that they are, indeed, correct actions.

It should be noted that in embodiments where the code representation of the web page is a DOM tree, the form values, selections of items in menus, markings of check boxes, selections of items in bullet lists and other form data may not be part of the DOM tree. In such embodiments the customer terminal is configured to extract such data, for example the form values, by using JavaScript code (that has previously been loaded through the web page code) to traverse the DOM tree for relevant elements and then for each found relevant element, extract the corresponding data. and attach them to a message carrying the code representation when the code representation is transmitted to the server. The server in turn adapts the web page corresponding to the code representation and includes the attached values and other data. The form values are thus comprised in the code representation of the web page along with the DOM tree. This enables the operator terminal to access a web page where all form values and possibly other data is as on the display of the customer terminal.

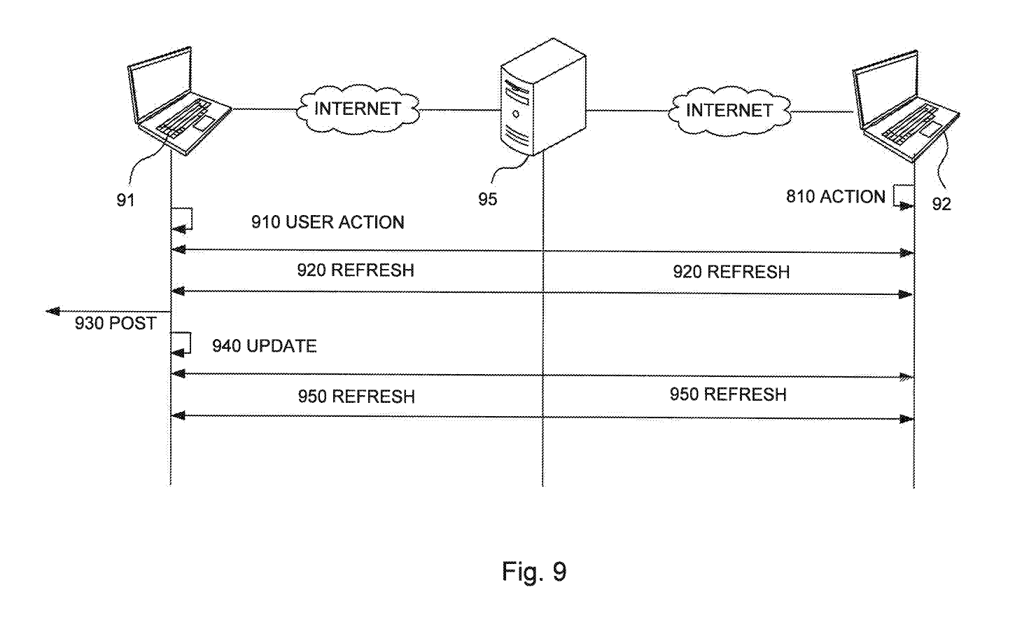

FIG. 9 shows a handshake diagram illustrating the functionality of such a user action and FIG. 7D shows the web page 70c as the user has performed a user action 910, in this example entering a value in the input field 73. In this example the user has entered the name “John” in the input field 73. Optionally the resulting web page 70c with the filled in input field 73 may be reflected on the operator terminal 92 by the customer terminal 91 initiating a refresh operation 920 as disclosed with reference to FIG. 6. Subsequent to entering the value in the input field 73, the user most likely posts or submits 930 the value of the input field 73 to the web server hosting the original web page and the corresponding web service, potentially an external web server not shown in FIG. 9. This will most likely influence the web page being visited, such as by automatic download of a different web page, or by presenting alternative data on the web page 70c, which is thereby updated 940, and the resulting web page may be reflected on the operator terminal 92 by the customer terminal 91 initiating a refresh operation 950 as disclosed with reference to FIG. 6.

It should be noted that other possible actions, both user and operator are possible. Some examples are entering data in a field, changing the data in a field, selecting a menu item, selecting an item in a bullet list, moving the mouse, time-triggered events or an event triggered by inactivity.

In one embodiment the server is configured to store the code representations for an assistance session. These stored code representations will then represent a history for the particular customer terminal (or customer using the customer terminal) and may be retrieved later for future purposes. This provides a simple manner of preserving a complete history of all actions taken.

It should be noted that by acquiring code representations from more than one customer terminal, one operator terminal will be able to assist more than one customer at a time. As the web page to be shared is downloaded from the web server as any other web page, multiple web pages can be viewed in different windows at the same time just as it is possible to view multiple web pages in a browser.

By incorporating the JavaScript code script in the code for the web page, no additional download of computer code is necessary. This provides for a faster initiation of an assistance session. Especially if JavaScript code is used, no pre-compilation is necessary and the script may be executed if needed without affecting the operation of the web browser if not needed.

One benefit of the teachings herein is that an operator is enabled to update a customer's view without taking control of any part of the customer's terminal. The operator is further able to do this or one specific and targeted customer. The customer does not have to take any special action at all, but simply remains logged on to the same web site. This is thus very simple to use and to understand. Especially if the assistance session is initiated by an operator as it then does not require any action by the customer. Furthermore no additional code sharing is needed to effectuate the sharing according to the teachings herein. This speeds up the assistance session and it also improves the security as there is no personal identification code than can be stolen, copied or stolen. Another benefit lies in that no direct connection between the operator and the customer terminal is established.

Another benefit of the teachings herein lies in that by simply sharing the code representation of the web page being viewed the operator has no access, visible or manipulatory to the user's other content. For example, the operator will be unable to see or view any other content presently being displayed on the customer's terminal. The personal integrity of the user of the customer terminal is thereby safe guarded.

Another benefit of the teachings herein lies in that by simply adapting the code representation of the web page, no further protocols need to be implemented or installed on the customer side. This also enables the operator to be independent of the customer's operating system. All data transformations and transfers are already taken care of by the internet protocol. The teachings herein thus also solve the problem of how to allow the operator to share data with any customer regardless of the operating system. A manner of sharing data, such as disclosed herein, thus becomes easy and thereby inexpensive to install at an operator side or operator web server as only a simple transformation between known web browsers and their corresponding DOM tree structures need be implemented.

The invention has mainly been described above with reference to a few embodiments. However, as is readily appreciated by a person skilled in the art, other embodiments than the ones disclosed above are equally possible within the scope of the invention, as defined by the appended patent claims.

1. A server (450) comprising a memory (240) and a controller (210), wherein said controller (210) is configured to
receive a code representation from a customer terminal,
adapt said code representation,
store said adapted code representation and
forward an address for accessing the adapted code representation to an operator terminal, thereby sharing a web page through its code representation between a customer terminal and an operator terminal.

2. The server (450) according to claim 1, wherein said controller (210) is further configured to receive an operator action event and cause said customer terminal to execute said operator action on said customer terminal.

3. The server (450) according to claim 1, wherein the code representation is retrieved by executing AJAX commands.

4. The server (450) according to claim 1, wherein said code representation comprises a DOM tree.

5. A method for use in a server (450), said method comprising
receiving a code representation from a customer terminal,
adapting said code representation,
storing said adapted code representation and
forwarding an address for accessing the adapted code representation to an operator terminal, thereby sharing a web page through its code representation between a customer terminal and an operator terminal.

6. A customer terminal (410) comprising a memory (240), a display (110) and a controller (210), wherein said controller (210) is configured to:
connect to a web server;
request and receive code corresponding to a web page from said web server and display said web page on a display (110);
retrieve a code representation of said web page from said memory and forward said code representation to a server (450) according to claim 1.

7. The customer terminal (410) according to claim 6, wherein said code corresponding to a web page includes a code segment for retrieving and forwarding the webpage code representation.

8. The customer terminal (410) according to claim 7 wherein said code segment is downloaded automatically along with the web page code.

9. The customer terminal (410) according to claim 7, wherein said code segment for retrieving and forwarding the webpage code representation is a JavaScript code script.

10. The customer terminal (410) according to claim 7, wherein said code segment for retrieving and forwarding the webpage code representation is a HTML code sequence.

11. The customer terminal (410) according to claim 7, wherein said code segment for retrieving and forwarding the webpage code representation is a combination of JavaScript code script and HTML code.

12. A method for use in a customer terminal (410) comprising a memory (240), a display (110) and a controller (210), said method comprising:
connecting to a web server;
requesting and receiving code corresponding to a web page from said web server and display said web page on a display (110);
retrieving a code representation of said web page from said memory and forwarding said code representation to a server (450) according to claim 1.

13. An operator terminal (420) comprising a memory (240) and a controller (210), wherein said controller (210) is configured to:
connect to a server (450) according to claim 1;
receive an address to an adapted copy of a web page;
access said adapted copy of a web page through the received address for obtaining a shared view of the web page.

14. The operator terminal (420) according to claim 13, wherein the controller is further configured to
receive an operator action and
send an indication of said operator action to said server for execution on a customer terminal.

15. A method for use in an operator terminal (420) comprising a memory (240) and a controller (210), said method comprising:
connecting to a server (450) according to claim 1;
receiving an address to an adapted copy of a web page;
accessing said adapted copy of a web page through the received address for obtaining a shared view of the web page.

16. A computer readable storage medium encoded with instructions that, when executed on a processor, perform the method according to claim 6.
